(19) United States
(12) Patent Application Publication
(10) Pub. No.: US 2012/0209642 A1
(43) Pub. Date: Aug. 16, 2012

(54) IDENTIFICATION OF TRADING ACTIVITIES OF ENTITIES ACTING IN CONCERT

(75) Inventor: Martin Jacobs, Teaneck, NJ (US)

(73) Assignee: Chicago Mercantile Exchange Inc., Chicago, IL (US)

(21) Appl. No.: 13/027,916

(22) Filed: Feb. 15, 2011

(51) Int. Cl. G06Q 40/00; G06Q 10/00

(52) U.S. Cl. 705/7.11

(57) ABSTRACT

Market participants that are ostensibly unrelated but acting in concert are identified using vector algebra. Position data for the market participants is collected using the large trader reporting system or through another method. The position data includes the position for a specific financial derivative for each of the market participants. Information derived from position data is used to populate a vector for each market participant. At least one pair of vectors is analyzed by calculating a parallel score indicative of an angle between the two vectors. The parallel score may be a cosine of the angle. The parallel score may be compared to a threshold parallel score to determine the likelihood that the pair of market participants are acting in concert. The threshold parallel score differs from market to market and may be determined by analyzing the distribution of parallel scores for the specific market.

### TECHNICAL FIELD

The following disclosure relates to software, systems and methods for surveillance of trading activities in an exchange or similar arrangement.

### BACKGROUND

From the infancy of futures markets regulation has been vital. Without regulation the largest market participants pose a threat to manipulate prices. To address these risks, large traders' positions must be reported periodically. Also, many market participants utilize more than one trading firm and more than one account with each trading firm, and accordingly, related accounts under the control of any market participant should be aggregated for regulatory purposes. Significant efforts are required to insure that accounts are properly aggregated.

For example, the Commodity Futures Trading Commission (CFTC), the Securities and Exchange Commission (SEC), and individual Exchanges require firms where certain market participants hold positions to report positions. However, some related market participants may not reveal themselves as related through fraudulent intent, mistake, confusion of the rules, or another reason. A system is needed to detect and identify related market participants acting in concert.

### BRIEF DESCRIPTION OF THE DRAWINGS

FIG. 1 illustrates an example of a system for the identification of trading activities of entities acting in concert.

FIG. 2 illustrates a comparison of two market participants.

FIG. 3 illustrates three example embodiments for constructing vectors for market participants.

FIG. 4A illustrates an example parallel score report.

FIG. 4B illustrates another example parallel score report.

FIG. 5 illustrates an example histogram distribution of parallel scores.

FIG. 6 illustrates an example algorithm for identifying trading activities of market participants acting in concert.

### DETAILED DESCRIPTION

The detection and identification of ostensibly unrelated market participants that are acting in concert improves the operation of the market. Statistical models for comparing market participant positions over time have proven complicated and unreliable. However, the following construction of the problem into a vector algebra model provides efficient and reliable identification of market participants acting in concert. The position data of the market participants is transformed into a list, which is mathematically a vector in a multi-dimensional vector space. Each dimension or component of each vector corresponds to a participant's position, change in position, or direction of change in position for a day or other time period (e.g. hour, minute, etc.). After a vector for each market participant to be compared has been constructed, an indication of the angle between each pair of vectors is calculated. The angle may be calculated by using the dot product identity. Alternatively, the cosine or another trigonometric function may be calculated as the indication of the angle between the vectors of each pair of market participants. As the angle between vectors approaches zero degrees, or as the cosine of the angle approaches one, the positions, changes in positions, or directions of changes in positions of the market participants become more similar.

The futures or options market for any asset is susceptible to price manipulation when a single entity obtains too large of a position. Price manipulation may be achieved through techniques referred to as corners, squeezes, and other schemes. For purpose of illustration only, the following is presented as an example of price manipulation. A trading entity obtains long position that is very dominant in a market. Although not required for success, the long position of the trading entity may be more than one hundred percent of the available supply of an asset for the delivery period. Any dominant position may drastically increase costs for other trading entities with short positions that must acquire the asset to make delivery. Accordingly, the market ceases to function.

Market regulation enables surveillance of large positions that may threaten price manipulation. In addition, if the market believes that market regulation is in place, markets tend to remain liquid. In addition, the surveillance of large positions also allows a regulator to understand the makeup of markets and how the markets function properly.

The data needed for surveillance of trading activities includes the positions of all trading entities or the positions a certain size or trading entities of a certain volume. The position data may be acquired by the exchange, self-reported by the trading entities, or a combination of both. Reporting is only reliable if the firms and/or market participants are willing and capable of reporting. The aggregation of market participants is vital to the reliability of the reporting system. Market participants or clearing firms must divulge common control so that they may be monitored as a single entity. Effectively, position limits are applied to the aggregated entities.

The market participants may act in concert through coincidence. For example, the two market participants in the same sector of the same industry may trade the same futures contracts and often respond to the same external factors. External factors may include for example, a drought, an oil spill, or tax legislation. In these situations the vectors of many market participants may appear similar. However, the degree of similarity may still be compared to separate the outliers.

The market participants may act in concert by design. A system that relies on self-reporting is subject to intentional misuse or inadvertent noncompliance. Some market participants may not complete the reporting correctly. Other market participants may intentionally mislead the Exchange or regulators about their ownership and/or control so as to appear unrelated to circumvent surveillance by the large trader reporting system. Still other market participants may act in concert through imitation. When trades are publicly known, one market participant may chose to imitate another market participant. Often, this involves the market participant taking positions in the same direction (i.e. increases or decreases in position relative to the previous position), but of a smaller size than the imitated market participant.

Market participants may have either “proportionate similarity” or “up-and-down similarity.” Proportionate similarity occurs when two market participants make the same or similar moves day by day. For example, a first market participant may have daily position changes of +1500, −1000, −600, and +2500 in a specific futures contract. A second market participant may follow the same pattern with some variation. The second market participant may have daily position changes of +1501, −987, −605, and +2498 in the specific futures contract. With a data set this small, the fact that the two market participants may be acting in concert is easily seen. However, as the data sets approach more realistic sizes a more sophisticated method is needed.

In addition, only some of the position changes over a given time period may be in concert, or small moves can be random or even in opposite direction but larger moves are in concert. For example, up-and-down similarity occurs when two market participants acting in concert do not make proportionate moves but instead go significantly up on the same days and/or go significantly down on the same days. Small moves on other days may be unrelated or insignificant, which may camouflage the concerted action or make the concerted action hard to recognize either by design or by coincidence.

For example, consider up-and-down similarity between a first market participant and a second market participant. The first market participant has daily position changes of +230, −50, −20, −700, and +1203 in a specific futures contract, and the second market participant has daily position changes of +120, +10, +10, −943, and +400 in the specific futures contract. The smallest moves are not proportional and not in the same direction. However, the largest moves are in the same direction. When the first market participant makes a large position change, the second market participant also makes a significant move in the same direction.

Depending on the types of similarities in any given market, the vectors for the market participants may be populated differently. Possible constructions include the total position, the change in position, or the direction of change in position. The total position construction uses the actual position data or value proportional to the position data. The change in position construction (arithmetic algorithm) uses the difference between the last position and the current position for each day or time period. The direction of change construction (up-and-down algorithm) uses the direction or sign of the movement between the last position and the current position for each day or time period.

The direction of change construction may use only a positive or negative sign for each day or time slice. For example using the first example above, the daily position changes of +1500, −1000, −600, and +2500 populate a vector as [+1, −1, −1, +1] and the daily position changes of +1501, −987, −605, and +2498 [+1, −1, −1, +1]. Mathematically, this forces the vectors closer together in the case of market participants that generally move in the same direction. In this specific example, the vectors are identical. Such an approach may be best suited to compare many days worth of position data.

Using the second example above the direction of the position changes, the daily position changes of +230, −50, −20, −700, and +1203 populate a vector as [+1, −1, −1, −1, +1] and the daily position changes of +120, +10, +10, −943, and +400 populate a vector as [+1, +1, +1, −1, +1]. The magnitude of the position changes is lessened. Therefore, the resulting angle between vectors does not reveal the seemingly trivial changes in positions during the second and third trading days or time slices.

Depending on the behavior of individual markets, one of the total position construction, the change in position construction, or the direction of change in position construction may be best suited to identify seemingly unrelated market participants acting in concert. For example, the particular algorithm or construction may be selected based on characteristics of a market for a particular contract. The optimal analytic approach or construction may be identified for each market or each time of year through sample size testing, trial and error, or a statistical analysis of the position data.

The time period for recording the positions, changes in position, or direction of the changes in position may also vary. Convenient data gathering and data manipulation may result from using daily end of day positions. However, other time periods such as hourly positions, minutely positions, weekly positions, monthly positions, or positions based on other time slices may also provide useful results. In particular, intraday time periods such as hourly can show concerted action during the trading day even when positions are closed out at the ends of each trading session and are not large-trader reported at all.

The positions of the market participants may come from any trading method, which may include but is not limited to an outcry system, an electronic trading engine, an over the counter system, by exercising an option, or by another method. If a market participant has a reportable position, then the position should be reported if it meets the requirements of the large trader reporting system.

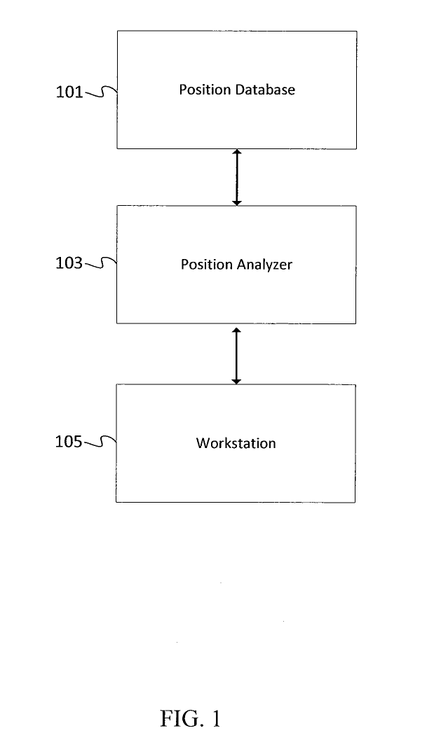

FIG. 1 illustrates an example of a system for the identification of trading activities of entities acting in concert. The system includes a position database 101, a position analyzer 103, and a workstation 105.

The position database 101 stores large trader data. The large trader data may be self-reported or automatically collected. Self-reported data may be required by a regulating body and/or an exchange. For example, the CTFC requires that each day, exchanges report each clearing member's open long and short positions, purchases, and sales, exchanges of futures for cash, and/or future delivery notices of the previous trading period. The reporting level for each contract is defined based on the market. The reporting level may range from 25 contracts to over 1,000 contract based on the total open positions in the market, the size of positions held by market participants, the surveillance history of the market, and the size of deliverable supplies for physical delivery markets.

Accordingly, the New York Mercantile Exchange (NYMEX), the Chicago Board of Trade (CBOT) and the Chicago Mercantile Exchange (CME), among others, require daily submission of large trader data, as set forth by CFTC Rule 17.00. Specifically, clearing members and omnibus customers submit a daily report of all individuals or entities, which own, control, or carry reportable positions in a single contract month for one futures contract or a single expiration month for a put or call option. The exchange may require more than one report per day. In addition, the number of open contracts in each month for a futures contract or in each expiration month for a put or call option in which any entity owns, controls, or carries open positions in a single contract month that equals or exceeds the reporting level for such contract. The reporting level for each contract is defined based on the market. Finally, a report may be required for any individual or entity owning, controlling, or carrying a position that meets or exceeds the reportable level in any month of a futures or options contract for all months of that futures contract and all corresponding options contracts, regardless of position size.

The position analyzer 103 identifies tracking activities that may indicate when unrelated entities are acting in concert. The position analyzer 103 may be embodied on a computer, a server, or a similar device as discussed below. The position analyzer 103 accesses the large trader data from the position database 101. The large trader data may include data associated with as few as two market participants to as many as thousands or millions of market participants.

The position analyzer 103 populates a vector for each market participant. The vector includes data indicative of positions, changes in positions, or directions of changes in positions included in the large trader data. The vector may take many forms, as discussed below. The position analyzer 103 may store internally or externally the vectors for the market participants.

The position analyzer 103 compares each market participant's vector with the vector of each other market participant. Alternatively, the position analyzer 103 compares a market participant's vector to a subset of the other market participants. For example, the position analyzer 103 calculates a parallel score between two vectors. The parallel score is indicative of an angle between the two vectors.

The parallel score may be calculated using the dot product of the vectors of the two market participants, as shown in equation 1. A resultant vector from a dot product of the first vector and the second vector is divided by a normalized vector of the first market participant and a normalized vector of the second market participant to determine the parallel score. The dot product may also be referred to as a scalar product or an inner product, and the parallel score.

$$Parallel Score = \frac{A \cdot B}{‖ A ‖ ‖ B ‖} = cos θ \qquad ( Equation 1 )$$

This process is repeated for each pair of vectors when the detection is wholesale so that each market participant is compared to each other market participant. Accordingly, there is no need identify suspected collaborators in advance. Alternatively, the parallel score may be used to investigate a subset of market participants.

If the vectors are nearly identical or parallel, the angle between them approaches 0, and the cosine approaches 1. If the vectors are completely unrelated, which indicates that the two market participants have no coordinated activities at all, the vectors will be nearly perpendicular, and the cosine approaches 0. If the two market participants have consistently opposite positions, the cosine approaches −1. Opposite positions could result from shuffling positions, money transfers (e.g., some market participants may attempt to use the exchange as an improper money transfer agent and/or as a scheme for tax evasion), or as a vehicle to move positions off their books to avoid large trader reporting requirements.

The parallel score is in indication of the angle between the vectors of the market participants being analyzed. Using Equation 1, this is naturally quantified using the cosine function. However, other quantities may be used. For example, the angle between the vector in radians or degrees may be the parallel score. Alternatively, other trigonometric function may be used. The trigonometric identities may combined with Equation 1 to derive addition equations for a parallel score that use one or more of sine, tangent, cotangent, cosecant, or secant. In addition, the unit vector for each market participant may be calculated as the vector divided by the magnitude of the vector. In this case, the dot product of the unit vectors of the market participants equals the parallel score, as shown by Equation 2.

Â·\hat{B}=cos θ=Parallel Score (Equation 2)

Using any of the trigonometric identities allows the detection of concerted action among market participants using the direction as opposed to only the magnitude of the position changes. Any difficulties in statistical analysis caused by market participants acting in the same direction but in different magnitudes are avoided. In addition, the vector treatment automatically weights the larger moves in concert more heavily than the small moves so that insignificant moves inserted periodically among significant and synchronized moves will not prevent accurate results.

The position analyzer 103 may calculate parallel scores for some or all pairs of market participants and transmit the parallel scores to workstation 105. The workstation may be a computer or other terminal and includes at least an input device, such as a keyboard or mouse, and a display. The parallel scores may be sorted in descending or ascending order quickly to identify the highest parallel scores. The position analyzer 103 may generate a report identifying all of the parallel scores or the parallel scores that exceed a threshold and transmit the report to workstation 105 to be displayed to a user. The report may also identify parallel scores that indicate a pair of vectors are anti-parallel. The report may include a more than one parallel score for each pair. For example, a first parallel score may be calculated using the change in position construction (arithmetic algorithm) and a second parallel score may be calculated using the direction of change construction (up-and-down algorithm). This type of double reporting reveals the several types of coordination discussed above.

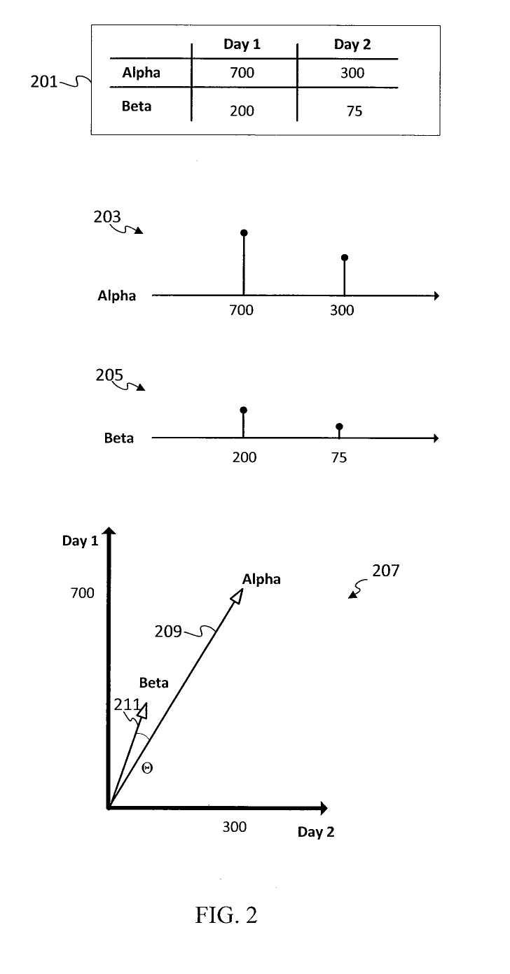

FIG. 2 illustrates a comparison of two market participants, Alpha and Beta, in the market for a single contract. The contract could be any financial derivative. A chart 201 compares the position data of Alpha and Beta. On day 1, Alpha holds a position of 700 contracts and Beta holds a position of 200 contracts. On day 2, Alpha reduces Alpha's position to 200 contracts and Beta reduces Beta's position to 75 contracts. In other words, Alpha and Beta have moved in the same direction but in different amounts and the proportion of the changes are similar but not identical.

A dot plot 203 and a dot plot 205 illustrate the same position data graphically. Because of the small size of the data set, casual observation reveals there may be concerted action. However, as the number of days increases and the number of market participants increases, similarities or patterns in the data are not detectable without a more sophisticated algorithm.

A chart 207 illustrates the same position data graphically as vectors in a two dimensional vector space, which corresponds to the two days in the position data. A vector 209 illustrates the day by day positions of market participant Alpha. A vector 211 illustrates the day by day positions of market participant Beta. The vector 209 and vector 211 are separated by an angle Θ. The angle Θ is an indication of the similarities between the day by day positions of market participant Alpha and market participant Beta.

An example parallel score for the position data of chart 201 may be calculated using Equation 1 to determine how close to parallel the two vectors are using the dot product. The following example uses the data from chart 201:

$$A = [ 700 \; 300 ] \\ B = [ 200 \; 75 ] \\ A \cdot B = ( 700 * 200 + 300 * 75 ) = 162500 \\ ‖ A ‖ = \sqrt{( 700 * 700 ) + ( 300 * 300 )} = \sqrt{580000} \\ ‖ B ‖ = \sqrt{( 200 * 200 ) + ( 75 * 75 )} = \sqrt{45625} \\ \begin{matrix}\frac{A \cdot B}{‖ A ‖ ‖ B ‖} = cos θ \\ = \frac{162500}{\sqrt{580000} \sqrt{45625}} \\ = 0.9989\end{matrix} \qquad ( Equation 1 )$$

Therefore, an example parallel score for the position data of chart 201 is 0.9989. Alternatively, the angle, which is 2.64 degrees or 0.046 radians, may be used as the parallel score.

The visual example of FIG. 2 illustrates a two dimensional vector space using data from only two time periods. Typically, useful results require a much larger set of position data. However, the calculations are applied easily to a vector in n-dimensional space, where n is a number of time periods. The time period may be a day. For example, typical vector spaces may be 20 dimensional vector space or 42 dimensional vector space. The dimension of the vector space may be tied to the number of trading days in a period. For example, 42 trading days in a two month time period. For example, time periods from 10 to 60 days seem to be useful for most types of contracts, and the final month of trading before delivery typically includes the most data.

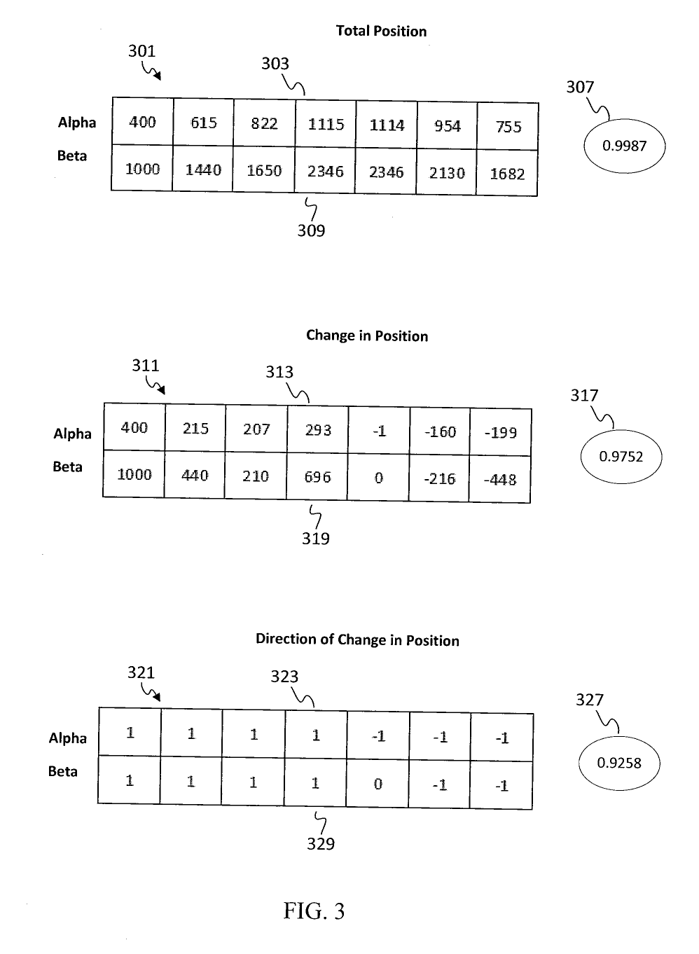

FIG. 3 illustrates three example embodiments for constructing vectors for market participants. The total position construction 301 includes the number of contracts for Alpha and Beta using Alpha vector 303 and Beta vector 309. The total position construction 301 involves a first vector is populated with values proportional to positions in the Alpha trading data and the second vector is populated with values proportional to positions in the Beta trading data. Using either Equation 1 or Equation 2 above, a parallel score using the cosine function is calculated as 0.9987.

The change in position construction 311 shown in FIG. 3 uses the number of contracts from the total position construction 301 to show the change in position from time period to time period. The change in position construction 311 may be referred to as arithmetic vectors. It is assumed that neither Alpha nor Beta had any position in the particular contract before the first time period, but this need not be the case. The change in position construction 321 includes an indication the change in contracts for Alpha and Beta using Alpha vector 313 and Beta vector 319. For example, the Alpha vector 313 (first vector) is populated with values that indicate a change in the positions in the Alpha trading data and the Beta vector 319 (second vector) is populated with values that indicate a change in the positions in the Beta trading data.

Using either Equation 1 or Equation 2 above, a parallel score using the cosine function is calculated as 0.9752. In the particular example shown, the change in position construction 311 shows less correlation than the total position construction 301. Alternatively, the change in position construction 311 could use the percentage change in position to better show concerted action between market participants of different magnitudes.

The direction of change in position construction 321 shown in FIG. 3 uses the direction of the change in contracts. The direction of change in position construction 321 may be referred to as up and down vectors. For any time period, if a market participant buys or otherwise acquires more contracts in the particular derivative, a 1 or +1 is shown. If the market participant sells or otherwise divests contracts in the particular derivative a −1 is shown. When no change or no significant change is made from one time period to the next, a zero is shown.

The direction of change in position construction 321 includes the direction of change in contracts for Alpha and Beta using Alpha vector 323 and Beta vector 329. For example, Alpha vector 323 (first vector) is populated with values that indicate a direction of a change in the positions in the Alpha trading data and the Beta vector 329 (second vector) is populated with values that indicate a direction of a change in the positions in the second trading data.

Using either Equation 1 or Equation 2 above, a parallel score using the cosine function is calculated as 0.9258. Using the direction of change in position construction 321, two market participants will have a parallel score of 1 when their daily changes always go in the same direction but by any amount. In the example shown, the contract change of a single contract between the fourth and the fifth position of the alpha vector 303 leads to the lower parallel score. The direction of change in position construction 321 moves vectors from the surface of a n-dimensional sphere and forces vectors to the corners, edge-midpoints, and face-centers of the n-dimensional cubes in the n-dimensional space.

The position analyzer 103 may calculate parallel scores using any combination of the total position construction 301, the change in position construction 311, and the direction of change in position construction 321. Particularly, calculating a first parallel score using the change in position construction 311 in combination with a second parallel score using the direction of change in position construction 321 provides the benefit of identifying both market participants with a few large correlated positions and market participants with several different changes in positions in the same direction. Concerted action in intraday trading may be best identified using this combination.

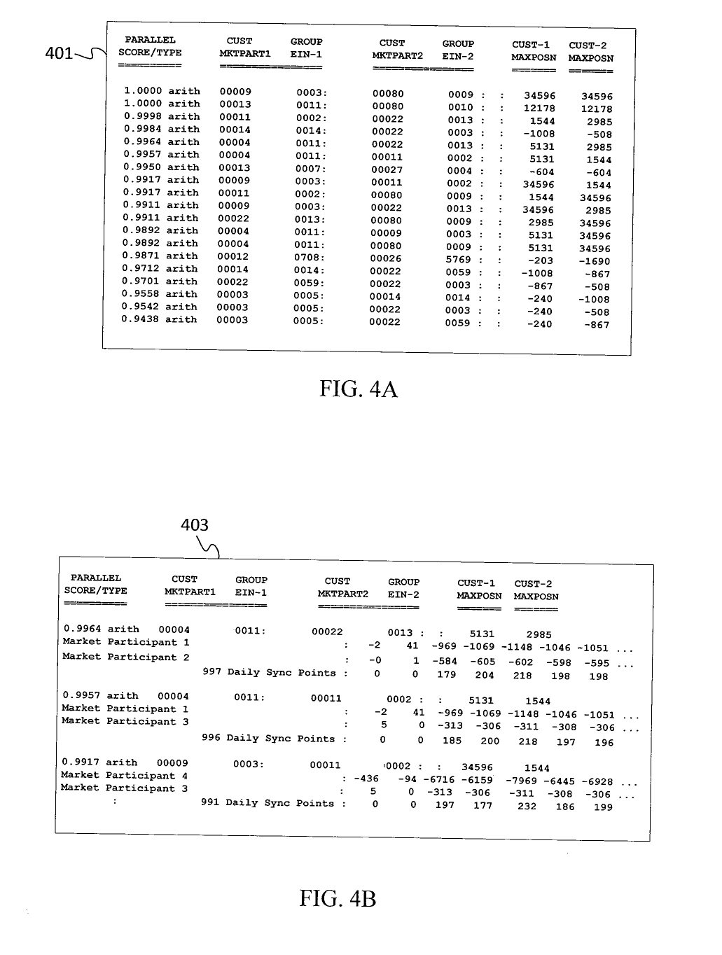

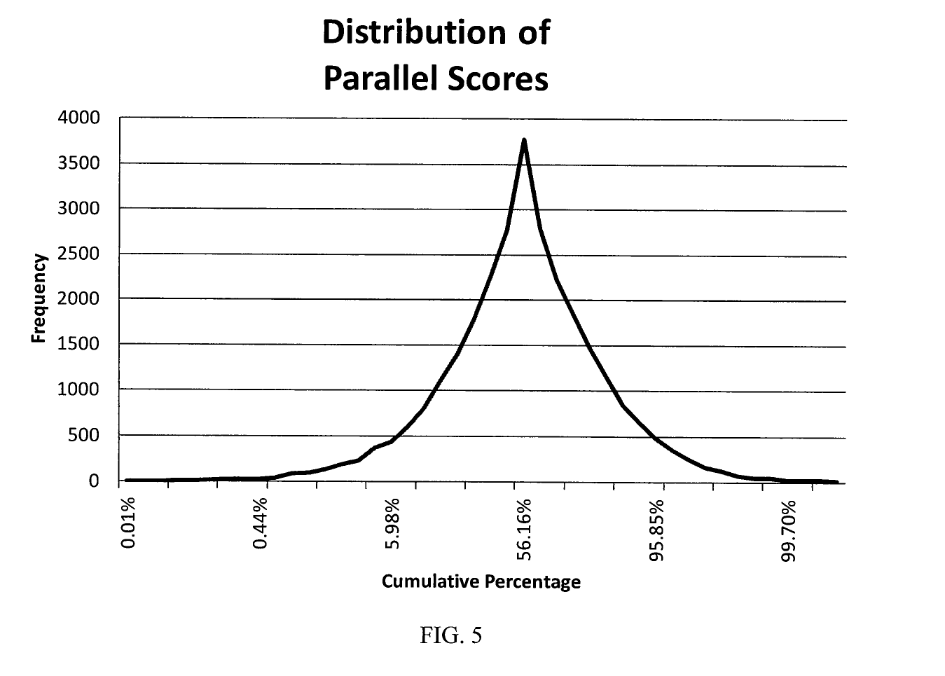

FIG. 4A illustrates an example parallel score report 401. The parallel score report ranks the market participants in ascending order of respective parallel scores. The adjacent column identifies the type of construction. In the case of parallel score report 401 only arithmetic vectors discussed above are used but other types are possible. The next column identifies the first market participant, concatenated with any associated aggregate groups of market participants, and the subsequent column identifies the second market participant, concatenated with any associated aggregate groups of market participants. The final two columns identify the maximum positions over the time period for the first market participant and the second market participant, respectively. The maximum positions give a quick indication of the type or size of the market participant but may not be direction used in calculating the parallel scores. However, the maximum positions may be used to select the type of construction.

FIG. 4B illustrates another example parallel score report 403. The parallel score report 403 may be used alone or in combination with the parallel score report 401. The report 403 includes the information of report 401 and also identifies the names of the market participants as well as the daily break down of synchronization points (sync points). Sync points divide the relatedness of the vectors among the time period. For example, each day may be allocated a number of sync points out of total possible in proportion to the amount that the day's activity contributed to the overall parallel score. The number of sync points is a weight that each time period applies to the parallel score. The number of sync points for each day may be calculated by manipulating the formula for the parallel score. For example, each term of the dot product A·B corresponds to a different time period. Each term is separated and substituted into Equation 1 to calculate the corresponding sync points.

If all or most of the sync points come from one day, there may be an increased likelihood that the two market participants are simply in the same business or reacting to the same external force. Market participants that simply trade in and trade out together on a couple instances are often not acting intentionally in concert. However, when the sync points are spread out over many days, the likelihood increases that the two market participants are acting in concert.

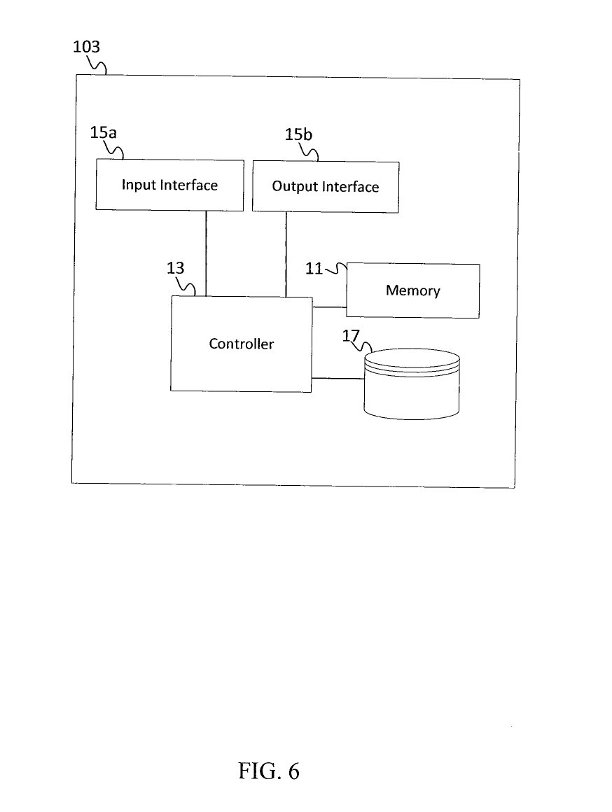

FIG. 5 illustrates an example histogram distribution of parallel scores. The histogram is a typical distribution for commodity markets. For example, the histogram may represent position data from the 42 trading days in May and June for July light crude oil futures (CL2010N). In total, the position data was derived from about 170 market participants. Where a parallel score is calculated for every pair of market participant, about 29,000 parallel scores were used for the histogram of FIG. 5. Out of the total parallel scores, less than 0.1% was correlated enough for a parallel score over 0.6000 and less than 0.0005% of the pairs were correlated enough for a parallel score over 0.8000. In one example, a threshold for identifying parallel scores indicative of concerted action may be 0.9900, 0.9500, 0.9000, 0.8000, 0.7000, 0.6000 or any increment in between. A histogram such as that shown in FIG. 5 may be used to identify an appropriate threshold parallel score for the particular market under investigation.

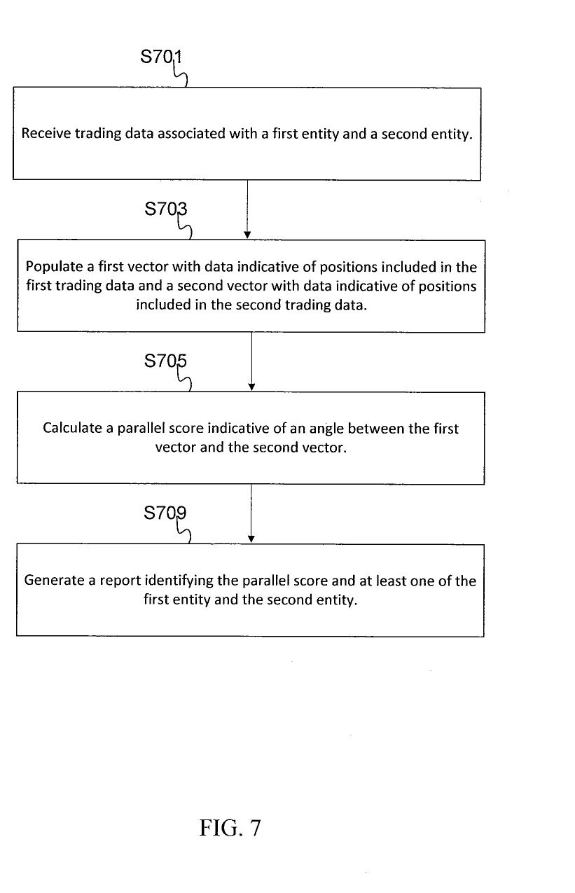

FIG. 6 illustrates the position analyzer 103 for the system for market surveillance of FIG. 1. The position analyzer includes a communication interface 15, a controller 13, a memory 11, and a database 17. The position database 101 may be integrated, or incrementally loaded into, the memory 11 or database 17.

The communication interface 15 may include an input communication interface 15a and an output communication interface 15b. The communication interface 15 is configured to establish connectivity with the position database 101 and the workstation 105. The communication interface may also establish communication with a network (not shown) such as the interne.

The memory 11 may be any known type of volatile memory or a non-volatile memory. The memory 11 may include one or more of a read only memory (ROM), dynamic random access memory (DRAM), a static random access memory (SRAM), a programmable random access memory (PROM), a flash memory, an electronic erasable program read only memory (EEPROM), static random access memory (RAM), or other type of memory.

The memory 11 may store computer executable instructions for the algorithms discussed herein. The controller 13 may execute the computer executable instructions. The computer executable instructions may be included in computer code. The computer code may be stored in the memory 11. The computer code may be written in any computer language which has algebraic computation capability, such as C, C++, C#, Java, Pascal, Visual Basic, Perl, Python, HyperText Markup Language (HTML), JavaScript, assembly language, extensible markup language (XML) and any combination thereof. For example, Javascript, HTML or XML may be utilized for the interface and display with an algebraic-computation capable language for the other algorithms. The computer code is encoded in one or more tangible media or one or more non-transitory tangible media for execution by the controller 13.

The instructions may be stored on any computer readable medium. The computer readable medium may be non-transitory. The computer readable medium may include, but is not limited to, a floppy disk, a hard disk, an application specific integrated circuit (ASIC), a compact disk CD, other optical medium, a random access memory (RAM), a read only memory (ROM), a memory chip or card, a memory stick, and other media from which a computer, a processor or other electronic device can read.

The controller 13 may include a general processor, digital signal processor, application specific integrated circuit, field programmable gate array, analog circuit, digital circuit, server processor, combinations thereof, or other now known or later developed processor. The controller 13 may be a single device or combinations of devices, such as associated with a network or distributed processing. Any of various processing strategies may be used, such as multi-processing, multi-tasking, parallel processing, remote processing, centralized processing or the like. The controller 13 may be responsive to or operable to execute instructions stored as part of software, hardware, integrated circuits, firmware, micro-code or the like. The functions, acts, methods or tasks illustrated in the figures or described herein may be performed by the controller 13 executing instructions stored in the memory 11. The functions, acts, methods or tasks are independent of the particular type of instructions set, storage media, processor or processing strategy and may be performed by software, hardware, integrated circuits, firmware, micro-code and the like, operating alone or in combination. The instructions are for implementing the processes, techniques, methods, or acts described herein.

The communication interface 15 may include any operable connection. An operable connection may be one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other or through one or more intermediate entities (e.g., processor, operating system, logic, software). Logical and/or physical communication channels may be used to create an operable connection. For example, a first communication interface 15b devoted to sending data, packets, or datagrams and a second communication interface 15a devoted to receiving data, packets, or datagrams. As used herein, the phrases “communication” and “coupled” are defined to mean directly connected to or indirectly connected through one or more intermediate components. Such intermediate components may include both hardware and software based components.

FIG. 7 illustrates an example algorithm for identifying trading activities of market participants acting in concert. More or fewer steps may be provided. At act S701, trading data is received. The trading data is associated with at least two market participants. The trading data may be large trader data, which may be self-reported by individual market participants or clearing firms. The trading data or position data may be stored in database 17 or memory 11. The trading data may be stored in position database 101 from previous trading session. The trading data may be collected and analyzed in real time.

At act S703, the controller 13 populates a vector for each of the market participants. The vector has n components or dimensions, where n is the number of time periods in the analyzed portion of the trading data. There may be as few as two time periods in the trading data. Typical time periods are from 10 days to 60 days. The time periods may also be divided in hourly increments to analyze intraday trading.

At act S705, the controller 13 calculates a parallel score indicative of an angle between each pair of vectors. As few as one pair of vectors may be analyzed. However, normally every market participant is paired with every other market participant. The controller 13 may also analyze a subset of the possible pairs of market participant. This may occur when certain market participants are suspected of acting in concert.

At act S709, the controller 13 generates a report identifying the parallel score for at least one pair of market participants. The report may also identify the market participants by name, trader ID, and/or group ID. The report may also sort the pairs of market participants according to the highest, or most correlated, parallel score. The report may also include those pairs of market participants above a threshold and exclude those pairs of market participants below the correction threshold. The threshold may be referred to as a similarity threshold or conceitedness threshold.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Regulated and unregulated exchanges and other electronic trading services make use of electronic trading systems. For example, the following embodiments are applicable to any trading or futures market in the United States or elsewhere in the world, for example, the Chicago Board of Trade (CBOT), the Chicago Mercantile Exchange (CME), the Bolsa de Mercadorias e Futoros in Brazil (BMF), the London International Financial Futures Exchange, the New York Mercantile Exchange (NYMEX), the Kansas City Board of Trade (KCBT), MATIF (in Paris, France), the London Metal Exchange (LME), the Tokyo International Financial Futures Exchange, the Tokyo Commodity Exchange for Industry (TOCOM), the Meff Renta Variable (in Spain), the Dubai Mercantile Exchange (DME), and the Intercontinental Exchange (ICE).

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer implemented method of identifying trading entities acting in concert, the method comprising:
receiving first trading data associated with a first entity and second trading data associated with a second entity;
populating a first vector with data indicative of positions included in the first trading data, changes in positions included in the first trading data, or directions of changes in positions included in the first trading data;
populating a second vector with data indicative of positions included in the second trading data, changes in positions included in the second trading data, or directions of changes in positions included in the second trading data;
calculating a parallel score indicative of an angle between the first vector and the second vector; and
generating a report identifying the parallel score, the first entity, and the second entity.

2. The computer implemented method of claim 1, further comprising:
comparing the parallel score to a threshold, wherein the report identifies the parallel score as exceeding the threshold.

3. The computer implemented method of claim 1, wherein the parallel score is a trigonometric function.

4. The computer implemented method of claim 3, wherein the trigonometric function is cosine.

5. The computer implemented method of claim 1, wherein calculating the parallel score further comprises:
calculating a resultant vector from a dot product of the first vector and the second vector;
normalizing the first vector as a first normalized vector;
normalizing the second vector as a second normalized vector; and
dividing the resultant vector by the first normalized vector and the second normalized vector to determine the parallel score.

6. The computer implemented method of claim 1, wherein the first vector is populated with values proportional to positions in the first trading data and the second vector is populated with values proportional to positions in the second trading data.

7. The computer implemented method of claim 1, wherein the first vector is populated with values that indicate a direction of a change in the positions in the first trading data and the second vector is populated with values that indicate a direction of a change in the positions in the second trading data.

8. The computer implemented method of claim 1, wherein the first vector is populated with values that indicate a change in the positions in the first trading data and the second vector is populated with values that indicate a change in the positions in the second trading data.

9. The computer implemented method of claim 1, wherein the first trading data and the second trading data include a plurality of time periods.

10. The computer implemented method of claim 9, further comprising:
calculating a quantity of sync points for each of the plurality of time periods, wherein the quantity of sync points indicates a weight of each time period on the parallel score.

11. An electronic surveillance system comprising:
a position database storing first trading data associated with a first entity and second trading data associated with a second entity;
a controller configured to calculate a parallel score indicative of an angle between a first vector and a second vector, wherein the first vector is populated with data indicative of positions for a plurality of time periods included in the first trading data and the second vector is populated with data indicative of positions for the plurality of time periods included in the second trading data; and
a reporting device configured to generate a report identifying at least one of the first entity and the second entity when the parallel score exceeds a threshold.

12. The electronic surveillance system of claim 11, wherein the trigonometric function is cosine.

13. The electronic surveillance system of claim 12, wherein the parallel score is determined by calculating a resultant vector from a dot product of the first vector and the second vector, normalizing the first vector and the second vector, and dividing the resultant vector by the first normalized vector and the second normalized vector to determine the parallel score.

14. The electronic surveillance system of claim 11, wherein the first vector is populated with values proportional to positions in the first trading data and the second vector is populated with values proportional to positions in the second trading data.

15. The electronic surveillance system of claim 11, wherein the first vector is populated with values that indicate a direction of a change in the positions in the first trading data and the second vector is populated with values that indicate a direction of a change in the positions in the second trading data.

16. The electronic surveillance system of claim 11, wherein the first vector is populated with values that indicate a change in the positions in the first trading data and the second vector is populated with values that indicate a change in the positions in the second trading data.

17. The electronic surveillance system of claim 1, wherein the controller is configured to determine a quantity of sync points for eachof the plurality of time periods, wherein the quantity of sync points indicates a weight of each time period on the parallel score.

18. A non-transitory computer readable medium containing instructions that when executed perform a method comprising:
receiving trading data associated with a plurality of market participants;
populating a vector for each of the plurality of market participants with data calculated from positions included in the trading data; and
calculating scores for each pair of vectors, wherein the score is indicative of an angle between each pair of vectors.

19. The non-transitory computer readable medium of claim 18, the method comprising:
comparing the scores to a threshold; and
generating a report that identifies pairs of market participants with respective scores above the threshold.

20. The non-transitory computer readable medium of claim 18, wherein the score is in the range of 0.6 to 1.0.
